(19) United States
(12) Patent Application Publication
(10) Pub. No.: US 2007/0140356 A1
(43) Pub. Date: Jun. 21, 2007

(54) IMAGE PROCESSING DEVICE, IMAGE PROCESSING METHOD, AND IMAGE PROCESSING SYSTEM

(75) Inventor: Takahisa Wada, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/565,873

(22) Filed: Dec. 1, 2006

(30) Foreign Application Priority Data
Dec. 15, 2005 (JP) 2005-362030

(51) Int. Cl. H04N 7/12

(52) U.S. Cl. 375/240.26

(57) ABSTRACT

An embodiment of the present invention is an image processing device which determines a reference frame for moving image compressing by inter-frame prediction, for each frame of a moving image, includes: a comparing section configured to compare, between frames of the moving image, sums of brightnesses of pixels in the respective frames, sums of brightnesses of pixels on a line or lines in a first direction of the respective frames, and sums of brightnesses of pixels on a line or lines in a second direction of the respective frames respectively, the second direction being nonparallel to the first direction; a judging section configured to judge whether or not there is a flash in each frame, based on a comparison result by the comparing section; and a determining section configured to determine a frame before the start of the flash to be a reference frame of a frame after the end of the flash, based on a judgement result by the judging section.

### CROSS REFERENCE TO RELATED APPLICATIONS

This application is based upon and claims the benefit of priority from the prior Japanese Patent Application No. 2005-362030, filed on Dec. 15, 2005, the entire contents of which are incorporated herein by reference.

### BACKGROUND OF THE INVENTION

1. Field of the Invention

The present invention relates to an image processing device, an image processing method, and an image processing system, for example to an image processing device, an image processing method, and an image processing system relative to moving image compressing by inter-frame prediction.

2. Background Art

A JPEG (Joint Photographic Coding Experts Group) scheme is widely used as a still image compression scheme, and an MPEG (Motion Picture Coding Experts Group) scheme is widely used as a moving image compression scheme. The JPEG scheme is classified into JPEG, JPEG 2000, etc., and the MPEG scheme is classified into MPEG 1, MPEG 2, H.264, etc. In the JPEG scheme, a still image is compressed by a conversion process, a quantization process, and an encoding process, and in the MPEG scheme, a moving image is compressed further by inter-frame prediction and motion prediction (see, for example, Japanese Patent Laid-Open No. 2002-185817 and Japanese Patent Laid-Open No. H. 11-225342).

Moving image compressing by inter-frame prediction, will now be described. When the moving image compressing of a moving image is performed, a reference frame for the moving image compressing is assigned to each frame of the moving image in advance. As for MPEG 1 and MPEG 2, only one reference frame can be assigned to one frame, and a reference frame of each frame is limited to an adjacent frame of each respective frame. However, as for H.264, a plurality of reference frames can be assigned to one frame, and a reference frame of each frame is not limited to an adjacent frame of each respective frame.

Such advantage of H.264 is useful when there is a flash or a scene change in a moving image. This is because a frame during a flush or a scene change often has a low similarity to its adjacent frame, so that the adjacent frame is often unsuitable as a reference frame of such a frame. Examples of moving images including flashes, are a motion picture obtained by shooting a scene of a bomb explosion, a motion picture obtained by shooting a scene of a photo shoot, an animation including a scene with a flash, and the like Examples of moving images including scene changes, are a motion picture in which shooting is interrupted and resumed, a motion picture for which picture editing is performed, and the like.

However, it is very difficult to find an appropriate reference frame for each frame of a moving image. Therefore, in practice, a scheme, in which a few frames preceding each frame are defined as reference frames for each respective frame, is generally employed because of its empirical validity. This scheme is likely to be suitable for a moving image including a scene change, but is likely to be unsuitable for a moving image including a flash. On the other hand, it is also possible that an appropriate reference frame for each frame of a moving image including a flash, is found by detecting an occurrence of the flash via calculating brightness. However, it is not efficient to detect an occurrence of the flash via calculating brightness without a special contrivance, because an amount of such calculation becomes huge.

### SUMMARY OF THE INVENTION

An embodiment of the present invention relates to, for example, an image processing device which determines a reference frame for moving image compressing by inter-frame prediction, for each frame of a moving image, including:

a comparing section configured to compare, between frames of the moving image, sums of brightnesses of pixels in the respective frames, sums of brightnesses of pixels on a line or lines in a first direction of the respective frames, and sums of brightnesses of pixels on a line or lines in a second direction of the respective frames respectively, the second direction being nonparallel to the first direction;

a judging section configured to judge whether or not there is a flash in each frame, based on a comparison result by the comparing section; and

a determining section configured to determine a frame before the start of the flash to be a reference frame of a frame after the end of the flash, based on a judgement result by the judging section.

Another embodiment of the present invention relates to, for example, an image processing method which determines a reference frame for moving image compressing by inter-frame prediction, for each frame of a moving image, including:

comparing, between frames of the moving image, sums of brightnesses of pixels in the respective frames, sums of brightnesses of pixels on a line or lines in a first direction of the respective frames, and sums of brightnesses of pixels on a line or lines in a second direction of the respective frames respectively, the second direction being nonparallel to the first direction;

judging whether or not there is a flash in each frame, based on a comparison result of the comparing; and

determining a frame before the start of the flash to be a reference frame of a frame after the end of the flash, based on a judgement result of the judging.

Another embodiment of the present invention relates to, for example, an image processing system including:

a first image processing device which determines a reference frame for moving image compressing by inter-frame prediction, for each frame of a moving image, including:

a comparing section configured to compare, between frames of the moving image, sums of brightnesses of pixels in the respective frames, sums of brightnesses of pixels on a line or lines in a first direction of the respective frames, and sums of brightnesses of pixels on a line or lines in a second direction of the respective frames respectively, the second direction being nonparallel to the first direction;

a judging section configured to judge whether or not there is a flash in each frame, based on a comparison result by the comparing section; and

a determining section configured to determine a frame before the start of the flash to be a reference frame of a frame after the end of the flash, based on a judgement result by the judging section; and

a second image processing device which performs the moving image compressing by the inter-frame prediction, using a determination result of the reference frame by the first image processing device.

### BRIEF DESCRIPTION OF THE DRAWINGS

FIG. 1 is a block diagram of an image processing system which performs moving image compression;

FIG. 2 is a diagram for illustrating a flash existing in a moving image;

FIG. 3 is a flowchart for illustrating a process by a first image processing device;

FIG. 4 is a diagram for illustrating a method for calculating sums of brightnesses: A, B, and C;

FIG. 5 is a diagram for illustrating a method for calculating differences between sums of brightnesses: ΔA, ΔB, and ΔC;

FIG. 6 is a diagram for illustrating a method for judging whether there is a flash or a scene change;

FIG. 7 is a diagram for illustrating a method for identifying an existence region of a flash;

FIG. 8 shows lines in a first direction and lines in a second direction that are orthogonal to each other;

FIG. 9 shows lines in a first direction and lines in a second direction that are nonparallel to each other; and

FIG. 10 is a diagram for illustrating accuracy in identification of object motion.

### DESCRIPTION OF THE EMBODIMENTS

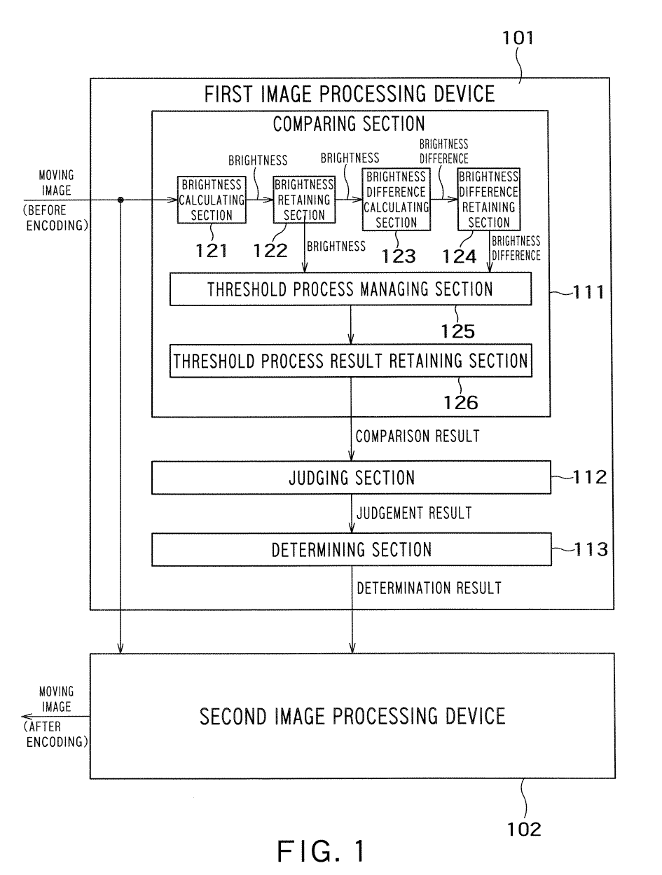

FIG. 1 is a block diagram of an image processing system which performs moving image compression. In the image processing system of FIG. 1, moving image compression conforming to H.264 (MPEG4AVC) of the MPEG scheme is performed.

The image processing system of FIG. 1 includes a first image processing device 101 which performs preparation of moving image compression, and a second image processing device 102 which performs the moving image compression. The first image processing device 101 is an image processing device which determines a reference frame for moving image compressing by inter-frame prediction, for each frame of a moving image. The second image processing device 102 is an image processing device which performs the moving image compressing by a conversion process, a quantization process, an encoding process, the inter-frame prediction, and motion compensation, for the moving image. A determination result of the reference frame by the first image processing device 101 is used for the inter-frame prediction by the second image processing device 102.

Image processing functions of the first image processing device 101 and the second image processing device 102 are assumed to be realized by integrated circuits such as LSIs, but they may be realized by programs implemented in ROM(s), HDD(s), or the like. In either case, the first image processing device 101 corresponds to an embodiment of the present invention.

The first image processing device 101 and the second image processing device 102 are assumed to be realized by separate integrated circuits or programs, i.e., are assumed to be separated as individual devices, but they may be realized by the same integrated circuit or program, i.e., may be integrated into the same device. In either case, the first image processing device 101 corresponds to an embodiment of the present invention.

The first image processing device 101 includes a comparing section 111, a judging section 112, and a determining section 113. The comparing section 111 includes a brightness calculating section 121, a brightness retaining section 122, a brightness difference calculating section 123, a brightness difference retaining section 124, a threshold process managing section 125, and a threshold process result retaining section 126.

The comparing section 111 is a block which compares, between frames of a moving image, sums of brightnesses of pixels in the respective frames (sums “A”), sums of brightnesses of pixels on a horizontal line of the respective frames (sums “B”), and sums of brightnesses of pixels on a vertical line of the respective frames (sums “C”) respectively Specifically, it is decided that whether or not sums of brightnesses of a first frame “A1”, “B1”, and “C1” differ from sums of brightnesses of a second frame “A2”, “B2”, and “C2” respectively, i.e., that whether or not differences of sums of brightnesses between both frames “|A1-A2|”, “|B1-B2|”, and “|C1-C2|” are greater than or equal to thresholds “α”, “β”, and “γ” (or greater than thresholds “α”, “β”, and “γ”) respectively. Calculation and retention of sums of brightnesses are performed by the brightness calculating section 121 and the brightness retaining section 122 respectively. Calculation and retention of differences of sums of brightnesses are performed by the brightness difference calculating section 123 and the brightness difference retaining section 124 respectively. Management of a threshold process and retention of a threshold process result are performed by the threshold process managing section 125 and the threshold process result retaining section 126 respectively.

The judging section 112 is a block which judges the presence and the location of the brightness variation of each frame of a moving image, based on a comparison result by the comparing section 111. The judging section 112 judges whether or not there is a flash or a scene change in each frame, based on the comparison result by the comparing section 111.

The determining section 113 is a block which determines a reference frame for each frame of a moving image, based on a judgement result by the judging section 112. The determining section 113 determines a frame before the start of a flash to be a reference frame of a frame after the end of the flash, based on the judgement result by the judging section 112.

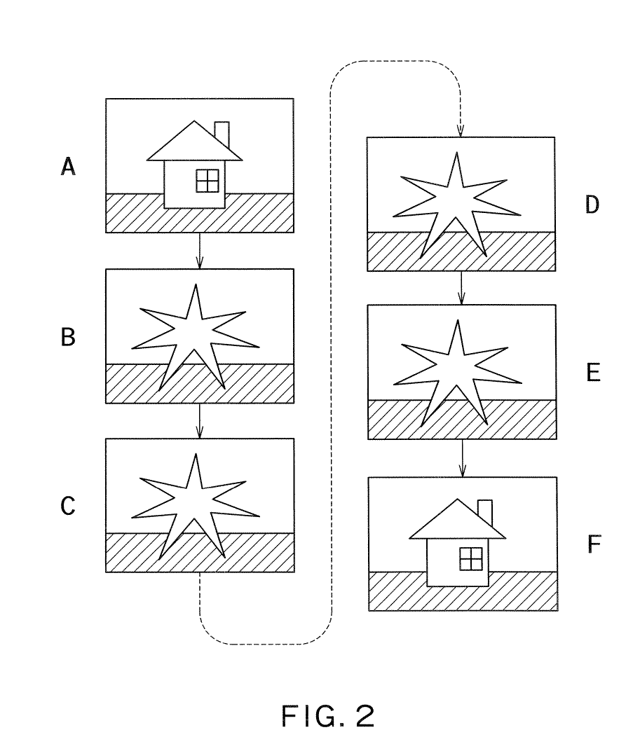

FIG. 2 is a diagram for illustrating a flash existing in a moving image. In FIG. 2, there are shown six frames A, B, C, D, E, F of a sequence of frames A, B, C, . . . , D, E, F constituting an moving image. Three frames A, B, C and three frames D, E, F are contiguous three frames, respectively.

There is a flash in the frame B, C, D, and E. The flash existing in the B, C, D, and E is a continuous flash wherein the frame B and the frame E are the start and the end of the flash respectively. The frame A corresponds to a frame just before the start of the continuous flash, and the frame F corresponds to a frame just after the end of the continuous flash.

In the present embodiment, the frame A just before the start of the continuous flash is determined to be a reference frame of the frame F just after the end of the continuous flash. This is because, in many cases, the frame F just after the end of the flash has a higher similarity to the frame A just before the start of the flash, than to the frame E just before the frame F. This improves a compression ratio of a moving image including a flash. In the present embodiment, the processes described above are performed through a comparison process of the comparing section 111, a judgement process of the judging section 112, and a determination process of the determining section 113.

It is noted that the application of the above-mentioned processes is not necessarily limited to a frame just before the start of a flash and a frame just after the end of a flash. For example, the previous frame of the frame just before the start of a flash may be determined to be a reference frame of the frame just after the end of the flash, and the frame just before the start of a flash may be determined to be a reference frame of the following frame of the frame just after the end of the flash.

In addition, the application of the above-mentioned processes is not necessarily limited to a continuous flash. For example, a frame just before the start of a continuous flash may be determined to be a reference frame of a frame just after the end of another continuous flash following thereto. In practice, with regard to a motion picture obtained by shooting a scene of many bomb explosions, a motion picture obtained by shooting a scene of photo shoots by many cameras, or the like, an attempt to detect boundaries of frequently occurring flashes is often insignificant.

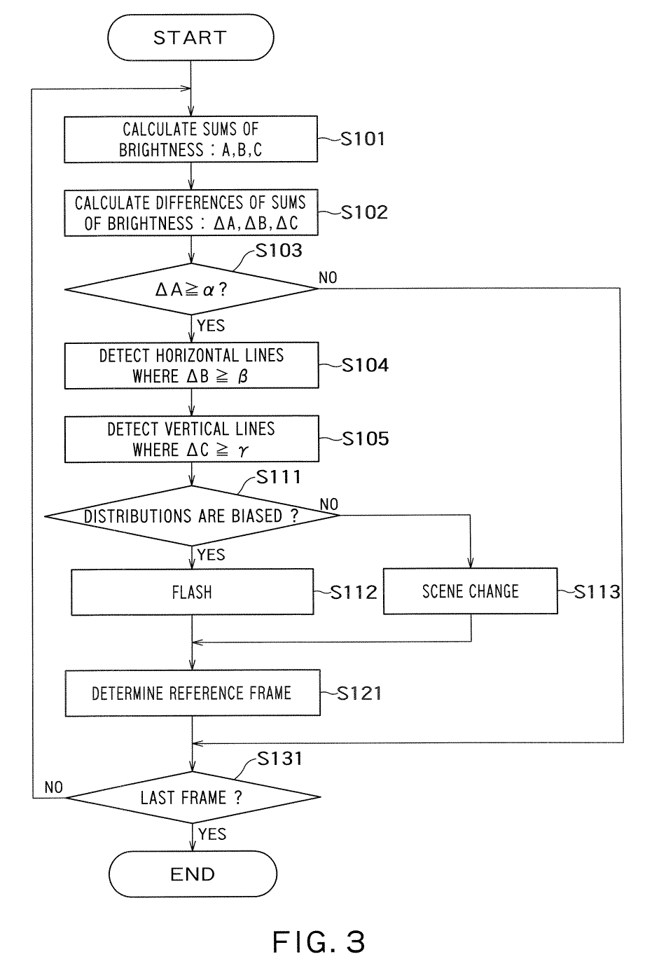

FIG. 3 is a flowchart for illustrating a process by the first image processing device 101 (preparation of moving image compression).

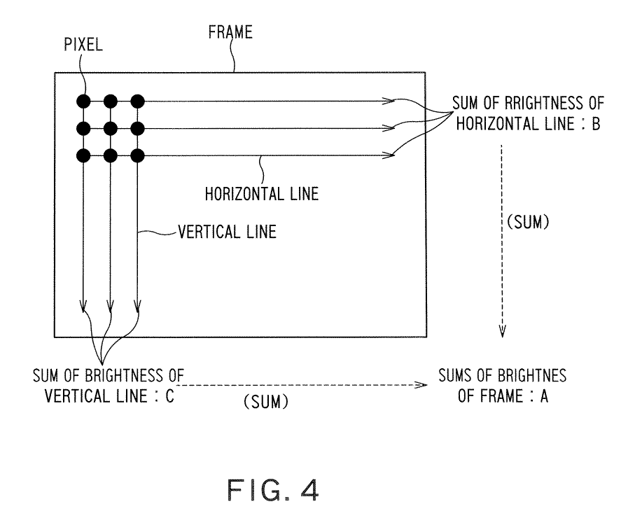

At first, in S101, the comparing section 111 calculates, for each frame of a moving image, a sum of brightnesses of all pixels in a frame (sum “A”), a sum of brightnesses of all pixels on a horizontal line of a frame (sum “B”), and a sum of brightnesses of all pixels on a vertical line of a frame (sum “C”) respectively. When a reference frame of N th frame is specified, sums of brightnesses “A”, “B”, and “C” of the N th frame and N−1 th frame (adjacent frame) are calculated. A method for calculating sums of brightnesses “A”, “B”, and “C” is shown in FIG. 4.

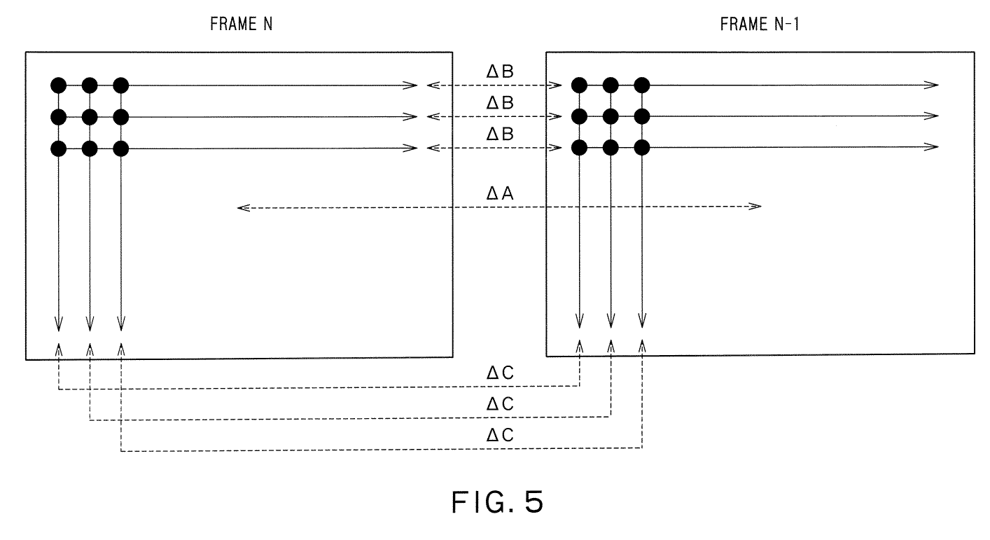

Then, in S102, the comparing section 111 calculates, between frames of the moving image, a difference of sums of brightnesses of all pixels in the respective frames (“ΔA”: difference of sums “A”), a difference of sums of brightnesses of all pixels on a horizontal line of the respective frames between lines corresponding to each other (“ΔB”: difference of sums “B”), and a difference of sums of brightnesses of all pixels on a vertical line of the respective frames between lines corresponding to each other (“ΔC”: difference of sums “C”). When a reference frame of N th frame is specified, differences of sums of brightnesses “ΔA”, “ΔB”, and “ΔC” between the N th frame and N−1 th frame are calculated. A method for calculating differences of sums of brightnesses “ΔA”, “ΔB”, and “ΔC” is shown in FIG. 5.

Then, in S103, the comparing section 111 decides, between the frames of the moving image, whether or not the difference of sums of brightnesses “ΔA” is greater than or equal to a threshold “α”. When a difference of sums of brightnesses “ΔA” between given frames is greater than or equal to a threshold “α”, brightnesses have been greatly changed between the frames. Therefore, in the flowchart, if a difference of sums of brightnesses “ΔA” between given frames is greater than or equal to a threshold “α”, the process will proceed on the assumption that a generation or an extinction of a flash or a scene change has occurred between the frames. When a difference of sums of brightnesses “Δ” between given frames is greater than or equal to a threshold “α”, the process about such frames proceed to S104, and when a difference of sums of brightnesses “ΔA” between the frames is smaller than the threshold “α”, the process about such frames proceed to S131. On the other hand, a sum of brightnesses “A” is not greatly changed only by a moving object within frames, and therefore a difference of sums of brightnesses “ΔA” between frames is not greatly increased by the moving object within the frames. Thus, the processing of S103 has an advantage that a generation and an extinction of a flash and a scene change can be distinguished from object motion.

Then, in S104, the comparing section 111 detects, between the frames of the moving image, an existence of horizontal lines corresponding to each other between which a difference of sums of brightnesses “ΔB” is greater than or equal to a threshold “β”.

Then, in S105, the comparing section 111 detects, between the frames of the moving image, an existence of vertical lines corresponding to each other between which a difference of sums of brightnesses “ΔC” is greater than or equal to a threshold “γ”.

Then, in S111, the judging section 112 judges whether or not there is a flash or a scene change in each frame, based on a comparison result of the comparing section 111. Specifically, it is judged that whether a generation or an extinction of a flash has occurred or not occurred (a scene change has occurred) between frames. This is judged based on “distributions” of horizontal lines whose differences of sums of brightnesses “ΔB” are greater than or equal to a threshold “⊕” and vertical lines whose differences of sums of brightnesses “ΔC” are greater than or equal to a threshold “γ”, between frames whose difference of sums of brightnesses “ΔA” is greater than or equal to a threshold “α”. It is judged by this judgement that whether there is a flash or is not a flash (is a scene change) in a frame to be processed.

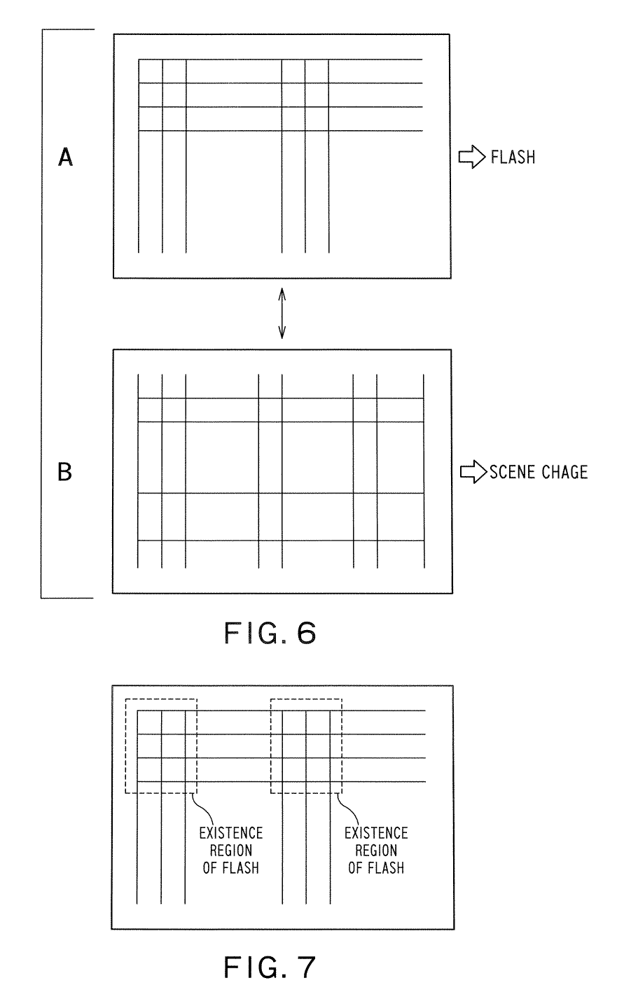

A method for judging whether there is a flash or a scene change is shown in FIG. 6. As shown in FIG. 6A, if distributions of horizontal lines whose differences of sums of brightnesses “ΔB” are greater than or equal to a threshold “β” and vertical lines whose differences of sums of brightnesses “ΔC” are greater than or equal to a threshold “γ” are biased, a judgement result is a flash (S112). As shown in FIG. 6B, if distributions of horizontal lines whose differences of sums of brightnesses “ΔB” are greater than or equal to a threshold “⊕” and vertical lines whose differences of sums of brightnesses “ΔC” are greater than or equal to a threshold “γ” are not biased, a judgement result is a scene change (S113). Whether the distributions are biased or not can be mechanically judged using a statistical method such as calculation of correlation.

When distributions of horizontal lines whose “ΔB” are greater than or equal to “⊕” and vertical lines whose “ΔC” are greater than or equal to “γ” are not biased, a difference between “ΔB between each pair of horizontal lines” and “ΔA/the number of pixels in vertical direction of a frame”, that is, a difference between “ΔB between each pair of horizontal lines” and “an average of ΔB between all pairs of horizontal lines” may be used additionally as a basis for judgement. Alternatively, a difference between “ΔC between each pair of vertical lines” and “ΔA/the number of pixels in horizontal direction of a frame”, that is, a difference between “ΔC between each pair of vertical lines” and “an average of ΔC between all pairs of vertical lines” may be used as a basis for judgement. When there are many pairs of lines whose differences between “ΔB” and “the average of ΔB” (or “ΔC” and “the average of ΔC”) are large, a judgement result is a flash because distributions of the differences of sums of brightnesses between lines are greatly biased. On the other hand, when there are not many pairs of lines whose differences between “ΔB” and “the average of ΔB” (or “ΔC” and “the average of ΔC”) are large, a judgement result is a scene change because distributions of the differences of sums of brightnesses between lines are not greatly biased.

Furthermore, in the processing of Slll, an existence region of a flash as well as a presence of a flash are identified. A method for identifying an existence region of a flash is shown in FIG. 7. In an existence region of a flash, horizontal lines whose “ΔB” are greater than or equal to “β” and vertical lines whose “ΔC” are greater than or equal to “γ” intersect as shown in FIG. 7. For this reason, the judging section 112 identifies a region where such horizontal lines and such vertical lines intersect, as an existence region of a flash. An identification result of existence region of a flash is useful especially when a reference frame of a frame is specified by the block of the frame. Specifically, with regard to a frame just after the end of a flash, the frame just before the start of the flash is determined to be a reference frame of a block that is in an existence region of the flash, and the preceding frame is determined to be a reference frame of a block that is not in the existence region of the flash. Thereby, a compression ratio of a moving image including a flash is further improved.

Then, in S121, the determining section 113 determines a reference frame of each frame, based on a judgement result of the judging section 112. Specifically, a frame just before the start of a flash is determined to be a reference frame of a frame just after the end of the flash, based on a judgement result of whether or not there is a flash in each frame. With regard to other frames, as a general rule, one or a few frames just before each frame is determined to be a reference frame of each frame. Further, based on a judgement result of whether or not there is a flash in each block of each frame, a frame just before the start of a flash may be determined to be a reference frame of a frame just after the end of the flash, for a block located in an existence region of the flash.

Additionally, a determination result of the determining section 113 is outputted from the determining section 113, to provide to the second image processing device 102. As a way to output the determination result, the determining section 113 may store the determination result in a storage medium accessible by the second image processing device 102 or may send the determination result to the second image processing device 102.

In addition, the determining section 113 may be configured to determine, instead of reference frames for all frames which constitute a moving image, a reference frame only for “a frame just after the end of a flash” which constitutes the moving image. In this case, reference frames of other frames are handled to be determined by default. Thereby, an information amount of a determination result can be reduced.

Then, in S131, it is decided that whether a process from S101 to S121 for each frame of the moving image is performed or not. Until the process from S101 to S121 for all frames of the moving image are executed, the process from S101 to S121 for each frame of the moving image is continued.

As described above, the first image processing device 101 judges whether or not there is a flash in each frame, and determines a frame before the start of a flash to be a reference frame of a frame after the end of the flash. This improves a compression ratio of a moving image including a flash. In this way, in the first image processing device 101, a reference frame of a frame constituting a moving image is determined properly.

Furthermore, the first image processing device 101 judges whether or not there is a flash in each frame of a moving image, using a simple calculation which compares, between frames of the moving image, sums of brightnesses of pixels in the respective frames (sums “A”), sums of brightnesses of pixels on a horizontal line of the respective frames (sums “B”), and sums of brightnesses of pixels on a vertical line of the respective frames (sums “C”) respectively. Thus, efficiency of a process for judging whether or not there is a flash in each frame of a moving image is improved. Therefore, in the image processing device 101, a reference frame of a frame constituting a moving image is determined efficiently.

Although a sum of brightnesses “B” and a difference of sums of brightnesses “ΔB” about a horizontal line and a sum of brightnesses “C” and a difference of sums of brightnesses “ΔC” about a vertical line, are calculated (and compared) by the line as described above, they may be calculated (and compared) by the plurality of lines. For example, “B”, “ΔB”, “C”, and “ΔC” may be calculated (and compared) by the block (i.e. 16 lines). In this way, “B” of each frame may be a sum of brightnesses of pixels on a horizontal line or horizontal lines of each frame, and “ΔB” between frames may be a difference of sums of brightnesses of pixels on a horizontal line or horizontal lines of the respective frames. Similarly, “C” of each frame may be a sum of brightnesses of pixels on a vertical line or vertical lines of each frame, and “ΔC” of between frames may be a difference of sums of brightnesses of pixels on a vertical line or vertical lines of the respective frames.

Although a sum of brightnesses “B” and a difference of sums of brightnesses “ΔB” about a horizontal line and a sum of brightnesses “C” and a difference of sums of brightnesses “ΔC” about a vertical line, are calculated (and compared) regarding all lines as described above, they may be calculated (and compared) regarding only a part of lines For example, “B”, “ΔB”, “C”, and “ΔC” may be calculated (and compared) regarding every other line. In this way, “B” of each frame may be calculated (and compared) regarding all horizontal lines or a part of horizontal lines of each frame, and “ΔB” between frames may be calculated (and compared) regarding all horizontal lines or a part of horizontal lines of the respective frames. Similarly, “C” of each frame may be calculated (and compared) regarding all vertical lines or a part of vertical lines of each frame, and “ΔC” between frames may be calculated (and compared) regarding all vertical lines or a part of vertical lines of the respective frames.

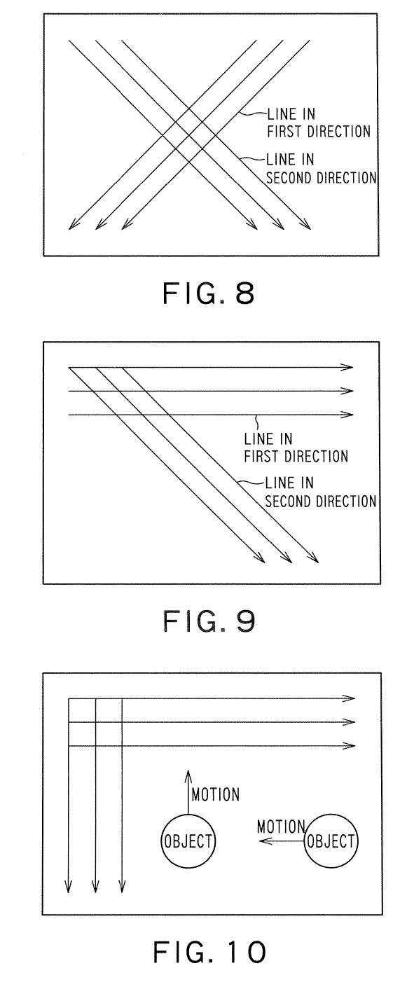

In addition, although a sum of brightnesses and a difference of sums of brightnesses about a line, are calculated regarding a horizontal line and a vertical line as described above, they may be calculated regarding a line in a first direction and a line in a second direction that are orthogonal to each other as shown in FIG. 8. Furthermore, they may be calculated regarding a line in a first direction and a line in a second direction that are nonparallel to each other as shown in FIG. 9. However, orthogonal lines are better than nonparallel lines in respect to accuracy in identification of object motion. Additionally, horizontal and vertical lines are better than just orthogonal lines in respect to ease of calculation (especially for calculation in an integrated circuit). It is noted that when a sum of brightnesses and a difference of sums of brightnesses about a line are calculated regarding a vertical line and a horizontal line, accuracy in identification of object motion is high in a horizontal direction and a vertical direction as shown in FIG. 10.

As described above, embodiments of the present invention provides an image processing device, an image processing method, and an image processing system which can properly and efficiently determine a reference frame for moving image compressing by inter-frame prediction, for each frame constituting a moving image.

What is claimed is:

1. An image processing device which determines a reference frame for moving image compressing by inter-frame prediction, for each frame of a moving image, comprising:
a comparing section configured to compare, between frames of the moving image, sums of brightnesses of pixels in the respective frames, sums of brightnesses of pixels on a line or lines in a first direction of the respective frames, and sums of brightnesses of pixels on a line or lines in a second direction of the respective frames respectively, the second direction being nonparallel to the first direction;
a judging section configured to judge whether or not there is a flash in each frame, based on a comparison result by the comparing section; and
a determining section configured to determine a frame before the start of the flash to be a reference frame of a frame after the end of the flash, based on a judgement result by the judging section.

2. The image processing device according to claim 1, wherein the comparing section compares, between frames of the moving image, sums of brightnesses of pixels in the respective frames, sums of brightnesses of pixels on a line or lines in the first direction of the respective frames, and sums of brightnesses of pixels on a line or lines in the second direction of the respective frames respectively, the second direction is orthogonal to the first direction.

3. The image processing device according to claim 2, wherein the comparing section compares, between frames of the moving image, sums of brightnesses of pixels in the respective frames, sums of brightnesses of pixels on a line or lines in horizontal direction of the respective frames, and sums of brightnesses of pixels on a line or lines in vertical direction of the respective frames respectively.

4. The image processing device according to claim 1, wherein the comparing section compares, between adjacent frames of the moving image, sums of brightnesses of pixels in the respective frames, sums of brightnesses of pixels on a line or lines in the first direction of the respective frames, and sums of brightnesses of pixels on a line or lines in the second direction of the respective frames respectively.

5. The image processing device according to claim 1, wherein the comparing section decides, between frames of the moving image, whether or not a difference of sums of brightnesses of pixels in the respective frames is greater than or equal to a threshold or greater than the threshold, whether or not a difference of sums of brightnesses of pixels on a line or lines in the first direction of the respective frames is greater than or equal to a threshold or greater than the threshold, and whether or not a difference of sums of brightnesses of pixels on a line or lines in the second direction of the respective frames is greater than or equal to a threshold or greater than the threshold, respectively.

6. The image processing device according to claim 5, wherein the comparing section decides, between frames of the moving image, whether or not a difference of sums of brightnesses of pixels in the respective frames is greater than or equal to a threshold or greater than the threshold, and if the difference is greater than or equal to the threshold or greater than the threshold, the comparing section decides, between the frames, whether or not a difference of sums of brightnesses of pixels on a line or lines in the first direction of the respective frames is greater than or equal to a threshold or greater than the threshold, and whether or not a difference of sums of brightnesses of pixels on a line or lines in the second direction of the respective frames is greater than or equal to a threshold or greater than the threshold, respectively.

7. The image processing device according to claim 1, wherein the judging section judges whether or not there is a flash or a scene change in each frame, based on the comparison result by the comparing section.

8. The image processing device according to claim 7, wherein the judging section judges whether or not there is a flash or a scene change in each frame, based on distributions of lines in the first direction whose differences of sums of brightnesses are greater than or equal to a threshold or greater than the threshold and lines in the second direction whose differences of sums of brightnesses are greater than or equal to a threshold or greater than the threshold.

9. The image processing device according to claim 1, wherein the judging section identifies an existence region of a flash in each frame, based on the comparison result by the comparing section.

10. The image processing device according to claim 9, wherein the judging section identifies, as a existence region of a flash, a region where lines in the first direction whose differences of sums of brightnesses are greater than or equal to a threshold or greater than the threshold, intersect with lines in the second direction whose differences of sums of brightnesses are greater than or equal to a threshold or greater than the threshold.

11. The image processing device according to claim 1, wherein the comparing section compares, between frames of the moving image, the sums of brightnesses of the first direction, by the line in the first direction, and the sums of brightnesses of the second direction, by the line in the second direction, respectively.

12. The image processing device according to claim 1, wherein the comparing section compares, between frames of the moving image, the sums of brightnesses of the first direction, by the lines in the first direction, and the sums of brightnesses of the second direction, by the lines in the second direction, respectively.

13. The image processing device according to claim 1, wherein the comparing section compares, between frames of the moving image, sums of brightnesses of pixels on a line or lines in the first direction of the respective frames, regarding all lines of the respective frames, and sums of brightnesses of pixels on a line or lines in the second direction of the respective frames, regarding all lines of the respective frames, respectively.

14. The image processing device according to claim 1, wherein the comparing section compares, between frames of the moving image, sums of brightnesses of pixels on a line or lines in the first direction of the respective frames, regarding a part of lines of the respective frames, and sums of brightnesses of pixels on a line or lines in the second direction of the respective frames, regarding a part of lines of the respective frames, respectively.

15. The image processing device according to claim 1, wherein a reference frame for each frame of the moving image, is determined by the block of each frame.

16. The image processing device according to claim 1, wherein a reference frame for the moving image compressing conforming to MPEG scheme, is determined for each frame of the moving image.

17. An image processing method which determines a reference frame for moving image compressing by inter-frame prediction, for each frame of a moving image, comprising:
comparing, between frames of the moving image, sums of brightnesses of pixels in the respective frames, sums of brightnesses of pixels on a line or lines in a first direction of the respective frames, and sums of brightnesses of pixels on a line or lines in a second direction of the respective frames respectively, the second direction being nonparallel to the first direction;
judging whether or not there is a flash in each frame, based on a comparison result of the comparing; and
determining a frame before the start of the flash to be a reference frame of a frame after the end of the flash, based on a judgement result of the judging.

18. The image processing method according to claim 17, wherein the comparing comprises comparing, between frames of the moving image, sums of brightnesses of pixels in the respective frames, sums of brightnesses of pixels on a line or lines in the first direction of the respective frames, and sums of brightnesses of pixels on a line or lines in the second direction of the respective frames respectively, the second direction is orthogonal to the first direction.

19. The image processing method according to claim 18, wherein the comparing comprises comparing, between frames of the moving image, sums of brightnesses of pixels in the respective frames, sums of brightnesses of pixels on a line or lines in horizontal direction of the respective frames, and sums of brightnesses of pixels on a line or lines in vertical direction of the respective frames respectively.

20. An image processing system comprising:
a first image processing device which determines a reference frame for moving image compressing by inter-frame prediction, for each frame of a moving image, comprising:
a comparing section configured to compare, between frames of the moving image, sums of brightnesses of pixels in the respective frames, sums of brightnesses of pixels on a line or lines in a first direction of the respective frames, and sums of brightnesses of pixels on a line or lines in a second direction of the respective frames respectively, the second direction being nonparallel to the first direction;
a judging section configured to judge whether or not there is a flash in each frame, based on a comparison result by the comparing section; and
a determining section configured to determine a frame before the start of the flash to be a reference frame of a frame after the end of the flash, based on a judgement result by the judging section; and
a second image processing device which performs the moving image compressing by the inter-frame prediction, using a determination result of the reference frame by the first image processing device.
